(19) United States
(12) Patent Application Publication
(10) Pub. No.: US 2026/0189178 A1
(43) Pub. Date: Jul. 2, 2026

(54) PHOTOVOLTAIC (PV) SYSTEM

(71) Applicant: Deer Management Systems, LLC, Caledonia, MN (US)

(72) Inventors: Garrison Peel, Caledonia, MN (US); Jeffrey Peel, Decorah, IA (US); Mario Bonardi, Billings, MT (US); Orrin Bigelow, Pohoa, HI (US)

(21) Appl. No.: 19/429,290

(22) Filed: Dec. 22, 2025

Related U.S. Application Data
(60) Provisional application No. 63/739,187, filed on Dec. 27, 2024.

(51) Int. Cl. H02S 20/30; F16M 13/02; H02J 7/35; H02J 7/80; H02J 101/24; H02S 10/40; H02S 30/10; H02S 30/20

(52) U.S. Cl. CPC H02S 20/30; F16M 13/022; H02J 7/35; H02J 7/80; H02S 10/40; H02S 30/10; H02S 30/20; H02J 2101/25; H02J 2207/30

(57) ABSTRACT

A photovoltaic system includes one or more solar panel modules, a mounting bracket coupled to the one or more solar panel modules, and a belt comprising a strap configured to be wrapped around a structure and selectively tightened. The mounting bracket includes one or more hooks that secure the mounting bracket and attached one or more solar panel modules to the structure by slipping over the strap and between a backside of the strap and a surface of the structure.

### CROSS-REFERENCE TO RELATED APPLICATIONS

The present application claims benefit of and priority to U.S. Provisional Application No. 63/739,187, filed Dec. 27, 2024, the contents of which is hereby incorporated herein by reference in its entirety.

### TECHNICAL FIELD

Aspects of the present disclosure relate to photovoltaic (PV) systems and more specifically to PV systems suitable for mounting to trees, poles, and/or other structures.

### BACKGROUND

Trail cameras may be mounted to trees, poles, or other structures in order to capture still images and/or video clips of wildlife within the field of view of the camera. Once deployed, the cameras are often left in the field for extended periods of time (e.g., weeks, months, or even years). Due to the remote nature of such deployments, photovoltaic (PV) systems may be deployed along side the cameras so as to provide the cameras with an electrical power source. In particular, a PV system may convert sunlight into electricity that charges external battery packs and/or internal batteries of the PV system, the camera, and/or other equipment. Moreover, the PV system may directly power associated cameras and/or other equipment during periods of sunlight. As a result, the cameras and/or other remotely deployed equipment may operate for extended periods of time (e.g., months, years, etc.) in remote locations.

Further limitations and disadvantages of conventional and traditional approaches will become apparent to one of skill in the art, through comparison of such approaches with some aspects of the present disclosure as set forth in the remainder of the present application with reference to the drawings.

### BRIEF SUMMARY OF THE DISCLOSURE

Shown in and/or described in connection with at least one of the figures, and set forth more completely in the claims, are photovoltaic (PV) systems suitable for mounting to a tree, post, pole, and/or other structure. In particular, a PV system may include a photovoltaic (PV) assembly comprising one or more solar panels and a mounting system for securing the PV assembly to a tree, post, pole, and/or other structure. In various embodiments, the mounting system may include a belt and a mounting bracket. The mounting bracket may be affixed or otherwise secured to the PV assembly. In various embodiments, the mounting bracket may be integrated into a housing of the PV assembly and/or otherwise secured to the PV assembly.

In use, the belt may wrap around a tree, post, pole, and/or other structure with a bit of slack between a back surface of the belt and the wrapped tree, post, pole, and/or other structure. In particular, the belt may be wrapped tight enough for the belt to generally remain in place while loose enough for one or more hooks of the mounting bracket to slip between the belt and a surface of the wrapped tree, post, pole, and/or other structure. After the hooks engage the belt, the belt may be tightened to firmly secure the hooks between the back surface of the belt and the surface of the tree, post, pole, and/or other structure. Such securing of the hooks effectively secures the mounting bracket and attached PV assembly to the tree, post, pole, and/or other structure.

These and other advantages, aspects, and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1 depicts a photovoltaic (PV) system in which its photovoltaic (PV) assembly is secured to a tree in a closed position.

FIG. 2 provides a perspective view of the PV system of FIG. 1 in which solar panels of the PV assembly are in an open position.

FIG. 3 provides a top view of the PV system of FIG. 1 in which solar panels of the PV assembly are in an open position.

FIG. 4 depicts a bottom view of the PV assembly with a mounting bracket of the PV system retracted into a recess in the PV assembly.

FIG. 5 depicts a bottom view of the PV assembly with the mounting bracket extended from the recess in the PV assembly.

FIG. 6 depicts a back view of the PV assembly with the mounting bracket extended from the recess in the PV assembly.

FIG. 7 depicts a back view of the PV assembly per a first mounting option in which the belt of the PV system is threaded through mounting loops of the mounting bracket.

FIG. 8 depicts a back view of the PV assembly per a second mounting option in which mounting hooks of the mounting bracket are slipped over an upper edge of the belt.

FIG. 9 provides a functional block diagram of the electrical components of the PV assembly.

### DESCRIPTION

The present disclosure is directed to a photovoltaic (PV) system comprising a PV assembly and mounting system for securing the PV assembly and its one or more solar panels to a tree, post, pole, or other structure. In various embodiments, the mounting system may include a mounting bracket and a belt. The belt may wrap around a tree, post, or other structure with sufficient slack to permit hooks of the mounting bracket to subsequently slip between a back surface of the belt and a surface of the tree, post, pole, or other structure. In particular, one or more hooks of the mounting bracket may slip over an upper edge of the belt and between a relatively vertical surface of the tree, post, pole, or other structure and a back surface of the belt. Once slipped over the upper edge of the belt, the belt may be tightened to secure the hooks of the mounting bracket between the back surface of the belt and the surface of the tree, post, pole, or other surface. Such securing of the hooks may effectively secure the PV assembly and its solar panels to the tree, post, pole, or other structure.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

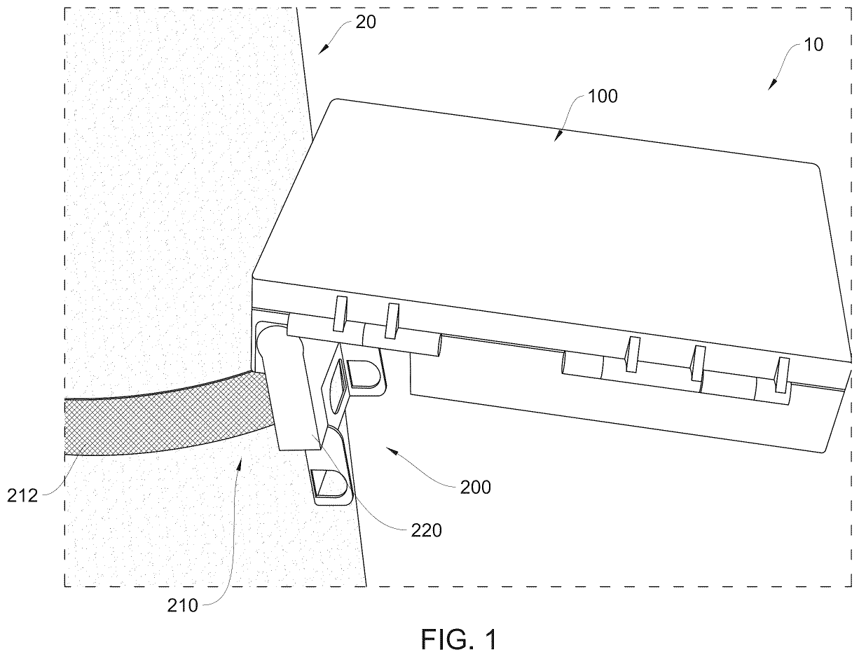

FIGS. 1-3 depict a photovoltaic (PV) system 10 comprising a photovoltaic (PV) assembly 100 and a mounting system 200 in accordance with various aspects of the present disclosure. In general, the PV assembly 100 includes one or more solar panels 110U, 110L that convert sunlight into electrical power and the mounting system 200 includes a belt 210 and a mounting bracket 220 that secure the PV assembly 100 to a tree, post, pole, and/or other structure.

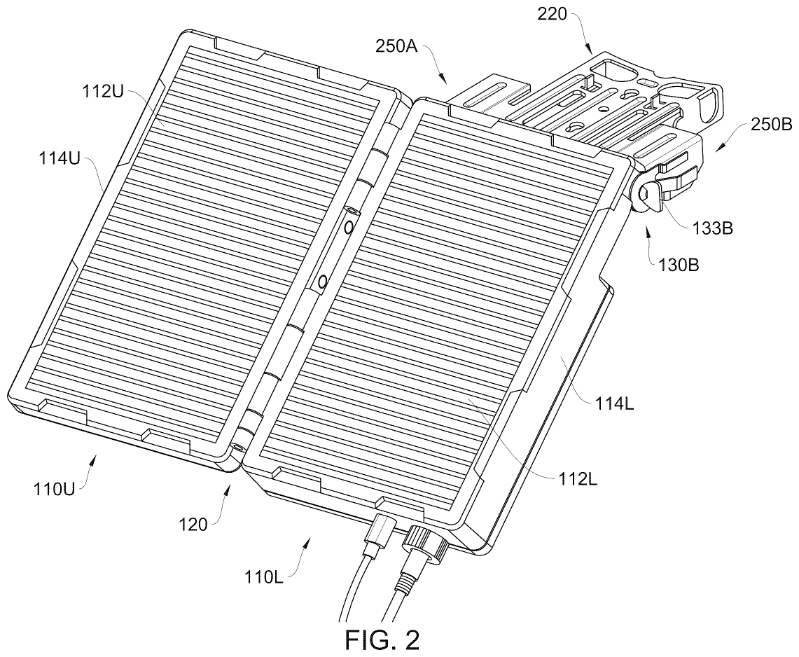

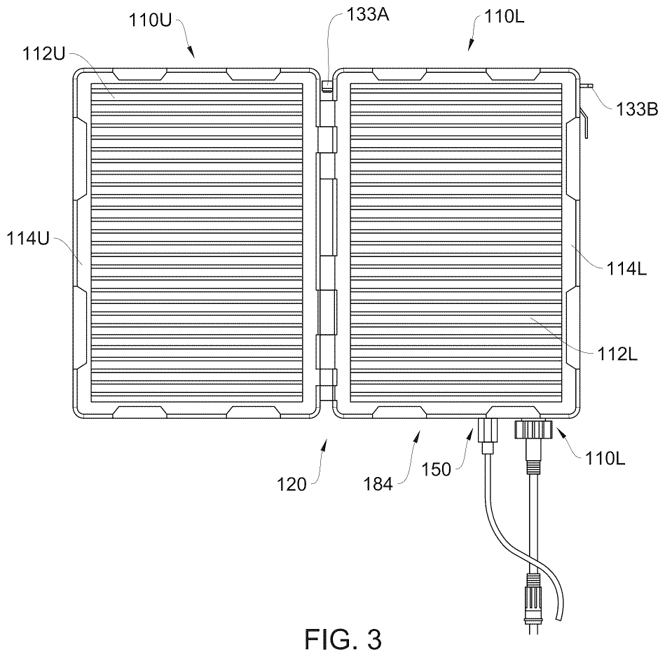

The belt 210 and the mounting bracket 220 are shown in FIG. 1 securing PV assembly 100 to a tree 20 with the solar panels 110U, 110L of the PV assembly 100 in a closed position. Conversely, FIGS. 2 and 3 depict the PV assembly 100 with its solar panel 110U, 110L in an open position.

The belt 210 may comprise a flexible band or strap 212 and a buckle or clasp (not shown), hereafter buckle. The buckle or portions thereof may be secured to one or both ends of the strap 212. In some embodiments, the buckle may secure one end of the strap 212 to another part of the strap 212 (e.g., at or near an end opposite the buckle or clasp) so as to form a closed loop. The buckle may take many suitable forms. However, per aspects of the present disclosure, the buckle may permit buckling and unbuckling of the belt 210 so as to transition between an open loop configuration and a closed loop configuration. When unbuckled, the strap 212 may be wrapped around a tree 20 or other structure and then buckled to form a closed loop around the tree 20. The buckle may further permit adjusting the diameter or length of the closed loop to permit tightening the belt 210 about an outer surface of the tree 20. The buckle may further permit loosening of the belt 210 and unbuckling of the belt 210 to permit unmounting and/or removal the PV assembly 100 from the tree 20.

As shown in FIGS. 1-3, the PV assembly 100 may include an upper solar panel 110U, a lower solar panel 110L, and a hinge 120 that joins the upper solar panel 110U to the lower solar panel 110L.

The lower solar panel 110L may include a lower solar panel housing 114L having a housing bottom, a housing top, and one or more housing sidewalls between the housing bottom and the housing top. The one or more housing sidewalls of the lower panel housing 114L may include a front sidewall, a back sidewall, and lateral sidewalls between the front sidewall and the back sidewall. Moreover, the one or more housing sidewalls may generally circumscribe the housing top and the housing bottom. As such, the lower solar panel housing 114L may general enclose or house the lower solar panel module 112L while exposing an upper surface of the lower solar panel module 112L and its solar cells through the housing top when in an open position.

Similarly, the upper solar panel 110U may include an upper solar panel housing 114U having a housing bottom, a housing top, and one or more housing sidewalls between the housing bottom and the housing top. The one or more housing sidewalls may include a front sidewall, a back sidewall, and lateral sidewalls between the front sidewall and the back sidewall. Moreover, the one or more housing sidewalls may generally circumscribe the housing top and the housing bottom. As such, the upper solar panel housing 114U may generally enclose or house the upper solar panel module 112U while exposing an upper surface of the upper solar panel module 112U and its solar cells through the housing top when in an open position.

The hinge 120 may provide a single axis of rotation between the upper solar panel 110U and the lower solar panel 110L. In particular, the hinge 120 may permit swinging a lateral side of the upper solar panel 110U that is opposite the hinge 120 away from a corresponding lateral side of the lower solar panel 110L that is also opposite the hinge 120. Such opening of the solar panels 110U, 110L may expose respective solar panel modules 112U, 112L and solar cells thereof.

In various embodiments, the hinge 120 may provide a rotation of about 180° about a single rotational axis. Such an embodiment may result in the exposed surfaces of the upper solar panel module 112U and the lower solar panel module 112L being coplanar with one another when fully opened. However, the hinge 120 in other embodiments may permit a greater or lesser rotation about the single rotational axis. Furthermore, the hinge 120, in some embodiments, may position the exposed surfaces of the upper solar panel module 112U and the lower solar panel module 112L such that they are not coplanar with one another when in a fully opened position.

As shown, the hinge 120 may run along corresponding lateral sidewalls of the upper solar panel 110U and the lower solar panel 110L. Such a configuration may orient the hinge 120 such that the single rotational axis extends radially away from the tree 20 to which the PV system 10 is attached. However, the hinge 120 may be oriented differently in other embodiments.

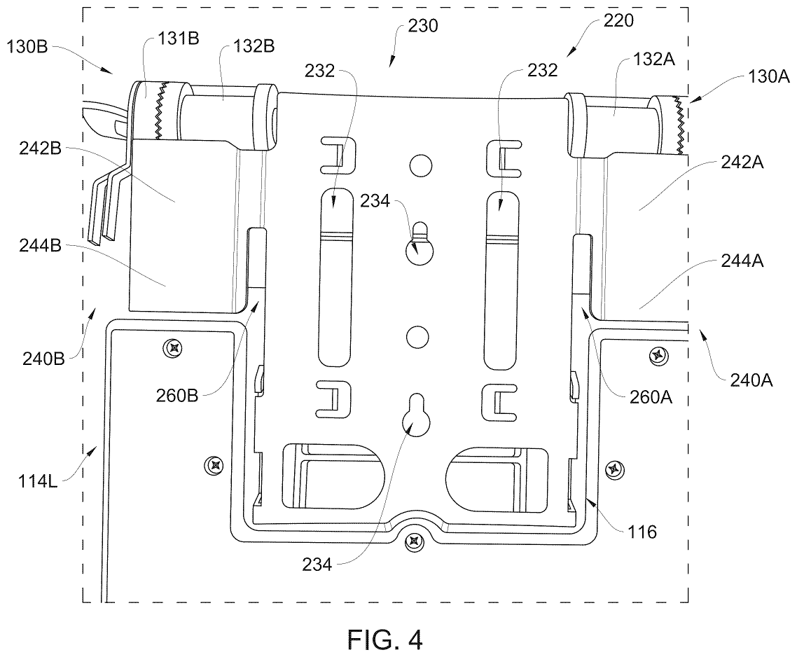

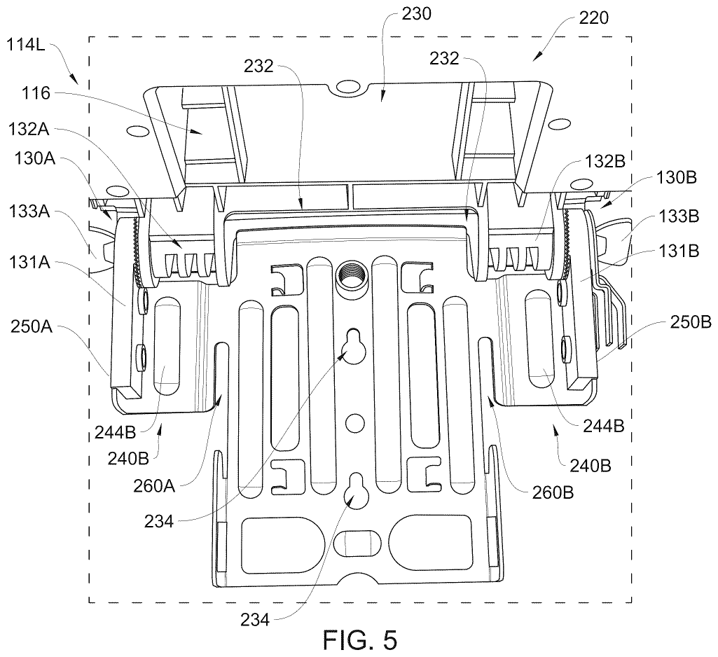

As shown in FIGS. 4 and 5, the housing bottom of the lower solar panel housing 114L may comprise a recess 116 sized to accommodate the mounting bracket 220 when in a retracted position. As shown, a proximal portion of the mounting bracket 220 may be coupled to the back sidewall of the lower solar panel housing 114L via serrated hinges 130A, 130B. In particular, a first serrated hinge 130A may couple a first flange 250A of the mounting bracket 220 to the lower solar panel housing 114L and a second serrated hinge 130B may couple a second flange 250B of the mounting bracket 220 to the lower solar panel housing 114L. Each serrated hinge 130A, 130A may comprise a hinge plate 131A, 131B with a serrated face that engages a serrated face of a hinge barrel 132A, 132B positioned toward and integrated into the back sidewall of the lower solar panel housing 114L. The hinge barrels 132A, 132B may be oriented such that each provides the serrated hinge 130A, 130B and attached mounting bracket 220 with a single rotational axis that is coaxially aligned with the other. In this manner, the mounting bracket 220 may pivot about the rotational axis of the serrated hinges 130A, 130B between a retracted position as shown in FIG. 4 and an extended position as shown in FIG. 5.

As further depicted, each serrated hinge 130A, 130B may include a fastener 133A, 133B. Each fastener 133A, 133B may be tightened to increase a force between opposing serrated faces of hinge plates 131A, 131B and hinge barrels 132A, 132B of the respective hinges 130A, 130B and prevent further rotation of the mounting bracket 220 about the rotational axis of the respective serrated hinge 130A, 130B. Conversely, each fastener 133A, 133B may be loosened to decrease a force between opposing serrated faces of the respective hinge 130A, 130B so as to permit further rotation of the mounting bracket 220 about the rotational axis of the respective serrated hinge 130A, 130B. In this manner, the fasteners 133A, 133B may effectively lock and unlock the mounting bracket 220 so as to obtain and retain a desired angle between the mounting bracket 220 and the housing bottom. In various embodiments, the fasteners 133A, 133B remain accessible even when mounted to a tree 20 as shown in FIG. 1. In such embodiments, the angle may be adjusted while remaining mounted to the tree 20 or other structure.

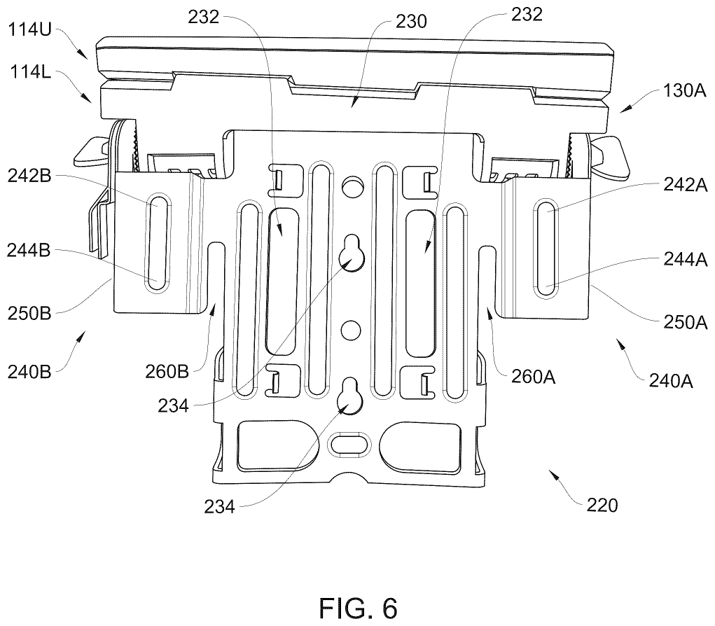

Referring now to FIG. 6, the mounting bracket 220 may include a central plate 230, belt hooks 240A, 240B, and lateral flanges 250A, 250B. The central plate 230 may have a generally rectangular shape with a proximal end associated with the serrated hinges 130A, 130B and the back sidewall of the lower solar panel housing 114L, a distal end opposite the proximal end, and lateral sides between the proximal end and the distal end.

The central plate 230 may further include belt loops 232 for securing the mounting bracket 220 to a structure via the belt 210 and mounting holes 234 for alternatively securing the mounting bracket 220 to a structure via one or more fasteners (e.g., screws, bolts, nails, etc.).

As shown, each belt loop 232 may provide an opening that passes through the central plate 230. Moreover, each belt loop opening may be sized to accommodate threading of the strap 212 through each belt loop 232. To this end, each belt loop opening may have a vertical height that is greater than a width of the strap 212 and a lateral width that is greater than a thickness of the strap 212 so as to permit threading of the strap 212 through the belt loops 232. As further shown, the belt loops 232 may be aligned vertically between the proximal end and the distal end and evenly distributed laterally between the lateral sides. Such an arrangement may aid in threading the strap 212 through the belt loops 232 and may help retain the mounting bracket 220 in a desired orientation when secured to a tree 20 or other structure via the belt 210.

As shown, the two belt hooks 240A, 240B may flank the lateral sides of the central plate 230. In particular, a first belt hook 240A may include a first base portion 242A and a first shaft 244A. The first base portion 242A may be coupled to the central plate 230 at a location near the proximal end of the central plate 230. A proximal end of the first shaft 244A may be coupled to the first base portion 242A with a distal end of the first shaft 244A extending from the first base portion 242A toward the distal end of the central plate 230. As shown, a lateral side of the first shaft 244A may run parallel to or along a corresponding first lateral side of the central plate 230, thus forming a first belt slot 260A between the first shaft 244A and the central plate 230.

Similarly, a second belt hook 240B may include a second base portion 242B and a second shaft 244B. The second base portion 242B may be coupled to the central plate 230 at a location near the proximal end of the central plate 230. A proximal end of the second shaft 244B may be coupled to the second base portion 242B with a distal end of the second shaft 244B extending from the second base portion 242B toward the distal end of the central plate 230. As shown, a lateral side of the second shaft 244B may run parallel to or along a corresponding lateral side of the central plate 230, thus forming a second belt slot 260B between the second shaft 244B and the central plate 230.

In various embodiments, the lateral width of each belt slot 260A, 260B may be greater than a thickness of the strap 212 of the belt 210. Similarly, the vertical length of each belt slot 260A, 260B may be greater than the width of the strap 212. However, the belt slots 260A, 260B are not so limited and may be shorter than the width of the strap 212. As long as each belt slot 260A, 260B is of sufficient length to receive a significant portion of the strap 212, the belt hooks 240A, 240B should reliably secure the PV assembly 100 to a tree 20 or other structure despite not receiving the full width of the strap 212.

While the mounting bracket 220 is depicted with two belt hooks 240A, 240B, other embodiments may include a different quantity of belt hooks. Moreover, such belt hooks may be positioned differently with respect to the central plate 230. For example, the mounting bracket 220 may include a single belt hook positioned in the center of the central plate 230.

As shown, the flanges 250A, 250B may flank the belt hooks 240A, 240B and the central plate 230. In particular, a first flange 250A may couple the first base portion 242A of the first belt hook 240A to a first hinge plate 131A of the first serrated hinge 130A and the second flange 250B may couple the second base portion 242B of the second belt hook 240B to a second hinge plate 131B of the second serrated hinge 130B. In particular, each flange 250A, 250B may protrude orthogonally from the general plane of the belt hooks 240A, 240B and the central plate 230 so as to provide the mounting bracket 220 with flanges suitable for affixing to the serrated hinges 130A, 130B. While depicted as protruding orthogonally backward with respect to the central plate 230, other embodiments may provide flanges that extend in a different angle (e.g., 80°) and/or in different direction (e.g., protruding forward) with respect to the central plate 230.

While the mounting bracket 220 is described as having several different components, in various embodiments the mounting bracket 220 may be stamped from a single sheet of metal and bent to form the noted components. As such, the mounting bracket 220 and its components may be formed as a single, integral plate. In such embodiments, the central plate 230 may comprise a generally planar front surface that faces away from the lower solar panel housing 114L and a generally planar back surface that faces the lower solar panel housing 114L when retracted into the recess 116 of the lower solar panel housing 114L. Further, each belt hook 240A, 240B may be formed such that each belt hook 240A, 240B is positioned forward of the front face of the central plate 230. Such positioning of the belt hooks 240A, 240B may offset or position the belt hooks 240A, 240B in a plane that is forward of the central plate and aid in slipping the belt hooks 240A, 240B over the strap 212 of the belt 210.

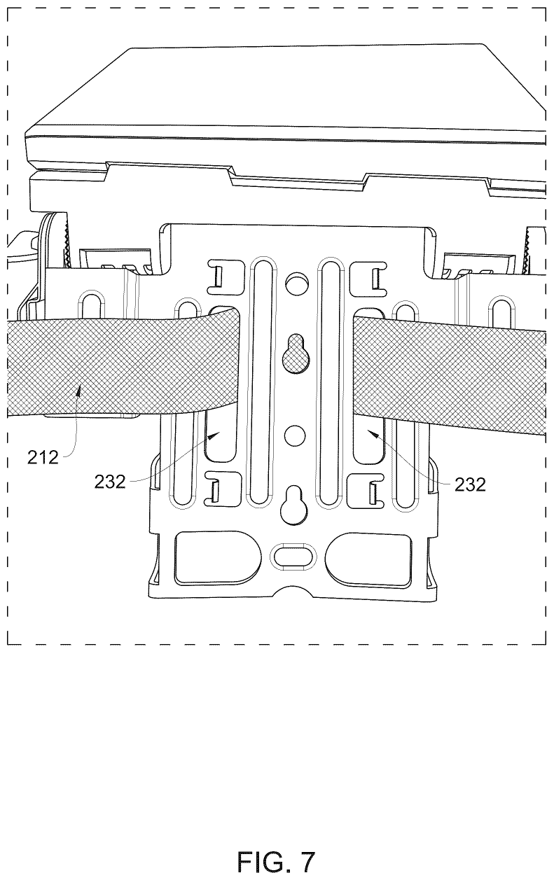

The above configuration of the mounting bracket 220 may provide a user of the PV system 10 with at least three mounting options. Per a first mounting option, the strap 212 of the belt 210 may be threaded through the belt loops 232 as shown in FIG. 7. After threading the strap 212 through the belt loops 232, the strap 212 of the belt 210 may be wrapped around a tree 20 or other structure, buckled to create a closed loop, and then tightened to secure the mounting bracket 220 and attached PV assembly 100 to the tree 20 or other structure. The PV assembly 100 may later be detached from the tree 20 by simply loosening and/or unbuckling the belt 210. Thus, permitting the PV system 10 to be easily unmounted from a tree or other structure and secured to another tree or structure.

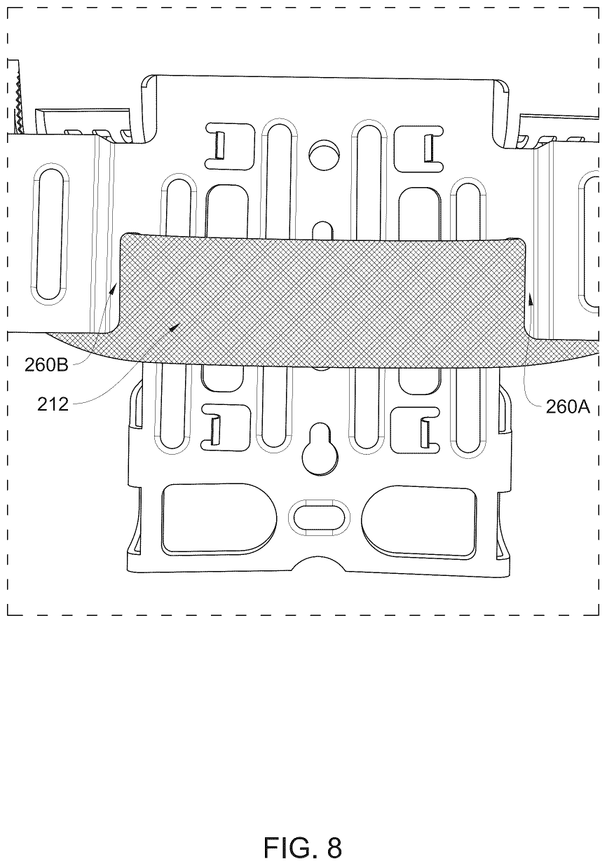

Per a second mounting option, the strap 212 of the belt 210 may be wrapped around a tree 20 or other structure, buckled to create a closed loop, and tightened enough to generally secure the belt 210 around the tree 20, while leaving enough slack to permit belt hooks 240A, 240B to slip over the upper edge of the strap 212 and between the back surface of the strap 212 and the tree 20. After securing the belt 210 to the tree 20 or other structure, the belt hooks 240A, 240B may slip over the upper edge of the strap 212 and thus resulting in the belt slots 260A, 260B receiving the strap 212 of the belt 210. See, FIG. 8 which depicts the engagement of the strap 212 with the belt hooks 240A, 240B and the belt slots 260A, 260B. The belt 210 may then be tightened to secure the mounting bracket 220 and attached PV assembly 100 to the tree 20 or other structure. The PV assembly 100 may later be detached from the tree 20 by simply loosening the belt 210 enough to permit lifting the belt hooks 240A, 240B from the strap 212 of the belt 210.

The second mounting option for various applications may be preferred over the first mounting option. In particular, compared to the first mounting options, the second mounting option is typically quicker and easier. Namely, per the second mounting option, one need not thread the strap 212 through the belt loops 232 of the mounting bracket 220, which saves time. Moreover, per the second mounting options, one wraps the belt 210 around the structure without the encumbrance of an attached PV assembly 100. After securing the belt 210, the PV assembly 100 may then be attached to the belt 210 by sliding the belt hooks 240A, 240B of the mounting bracket 220 over the belt 210. Conversely, wrapping and securing the belt 210 around the structure per the first mounting option can be a challenge due to weight and bulk of the already attached PV assembly 100. Such wrapping and securing can be even more cumbersome when attempting to attach at to a tall structure via a ladder and/or climbing the structure itself.

Per a third mounting option, a person may screw, hammer, or otherwise secure one or more fasteners (e.g., screws, bolts, nails, etc.) through the mounting holes 234 of the central plate 230 and into a structure. The third mounting option may provide a more secure and more permanent mounting of the PV system 10 to a structure, but at the expense of possibly harming the structure to which the PV system 10 is attached and at the expense of requiring more effort to mount and/or possibly dismount the PV system 10 to/from the structure than the above-note first mounting option and the second mounting option.

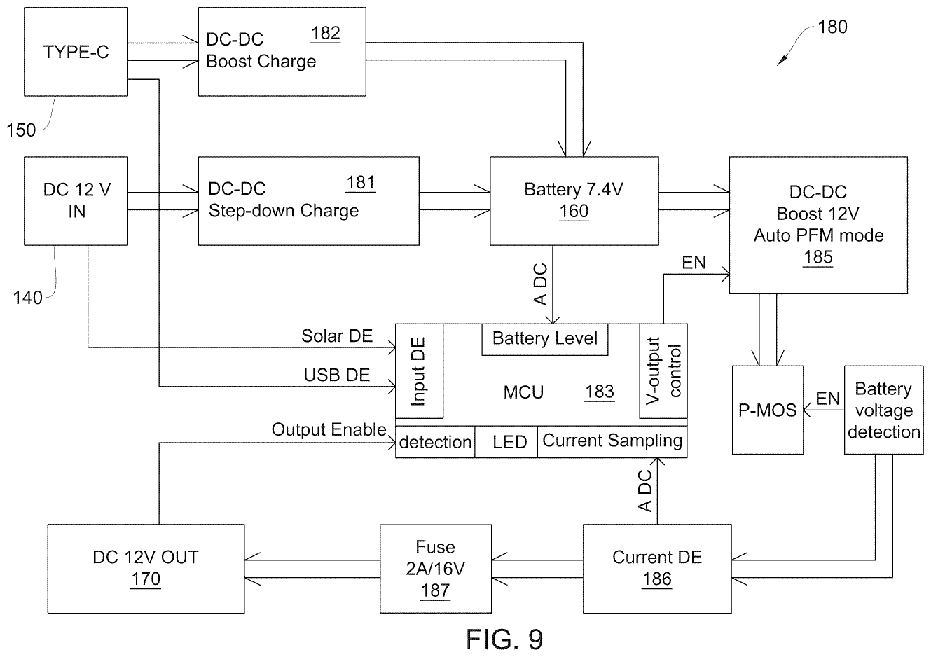

Referring now to FIG. 9, a functional block diagram of the electrical components of the PV assembly 100 is shown. As shown, the PV assembly 100 may include a first charging port 140, a second charging port 150, one or more battery cells 160, one or more output ports 170, and control circuitry, software, and/or firmware, hereafter control circuitry 180. The first charging port 140, the second charging port 150, and the control circuitry 180 may cooperate to charge the one or more battery cells 160. Moreover, the control circuitry 180 may direct electrical power from the one or more battery cells 160 to the one or more output ports 170. In various embodiments, the PV assembly 100 may provide the output ports 170 with a total working output voltage of 13.2V and a maximum output current of 550 mA.

To this end, the one or more battery cells 160 may include four 18650 battery cells with 2500 mAH for a total capacity of 7.2V/36 Wh. The solar panel modules 112L, 112U may each include 3.6 W monocrystalline LSH733 solar panel modules. The solar panel modules 112L, 112U may be connected in series to dedicated solar charging circuitry 181 via the first charging port 140, which provides DC charging power to the one or more battery cells 160. To this end, the solar charging circuitry 181 may include high-efficiency dedicated solar charging chips that are equipped with NTC battery temperature detection and maximum power point tracking (MPPT).

Similarly, the second charging port 150 may be coupled to the one or more battery cells 160 via charging circuitry 182. In various embodiments, the charging port 150 may comprise a USB port (e.g., USB-C port), but other embodiments may utilize a different port type. The charging circuitry 182 may include an efficient and high-precision two-stage charging management chip, which has three charging modes: trickle current, constant current, and constant voltage. The charging circuitry 182 may also include overvoltage and undervoltage protection as well as external NTC battery temperature protection for the one or more battery cells 160. In various embodiments, the second charging port 150 and charging circuitry 182 may cooperate to provide a maximum charging current of 2.5 A.

The control circuitry 180 may include a micro-controller 183 that monitors and generally controls the PV assembly 100. In particular, an analog-to-digital converter (ADC) input of the micro-controller 183 may be coupled to the one or more battery cells 160 so as to monitor an analog power level of the one or more battery cells 160. Based on the detected level, the micro-controller 183 may selectively light one or more light emitting diodes (LED) indicators. For example, the PV assembly 100 may comprise a four LED indicator 184 and the micro-controller 183 may illuminate one LED when the power level is between 0% and 25%, may illuminate two LEDs when the power level is between 25% and 50%, may illuminate three LEDs when the power level is between 50% and 75%, and may illuminate all four LEDS when the power level is between 75% and 100% of its fully charged level. Furthermore, the micro-controller 183 may detect the presence of power from the first charging port 140 and/or the second charging port 150 and enable/disable accordingly so as to charge the one or more battery cells 160 from a single source.

The control circuitry 180 may further include a high power and efficient synchronous boost converter 185 that boosts the power provided by the one or more battery cells 160 to levels suitable for the output ports 170. In various embodiments, the boost converter 185 may deliver an output efficiency up to 91% via an automatic light load pulse frequency modulation (PFM) mode. The boost converter 185 may be further equipped with 13.2V output overvoltage protection, may support cycle by cycle overcurrent protection, and may provide overheating protection.

The control circuitry 180 may further include current control circuitry 186 and a self recovery current limiting 2 A fuse 187. The current control circuitry 186 may be coupled to another analog-to-digital port of the micro-controller 183. In this manner, the micro-controller 183 may monitor a load current in real-time and control the load output based on the monitored current.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. A photovoltaic system, comprising:
one or more solar panel modules;
a mounting bracket coupled to the one or more solar panel modules; and
a belt comprising a strap configured to be wrapped around a structure and selectively tightened; and
wherein the mounting bracket comprising one or more hooks that secure the mounting bracket and attached one or more solar panel modules to the structure by slipping over the strap and between a backside of the strap and a surface of the structure.

2. The photovoltaic system of claim 1, wherein the one or more hooks includes a first hook and a second hook.

3. The photovoltaic system of claim 2, wherein the mounting bracket comprises a central plate between the first hook and the second hook.

4. The photovoltaic system of claim 3, wherein:
the first hook includes a first shaft that runs along a lateral side of the central plate to form a belt slot sized to receive at least a portion of the strap; and
the second hook includes a first shaft that runs along a lateral side of the central plate to form a belt slot sized to receive at least a portion of the strap.

5. The photovoltaic system of claim 1, wherein the mounting bracket is coupled to the one or more solar panel modules via one or more hinges.

6. The photovoltaic system of claim 1, wherein the mounting bracket is coupled to the one or more solar panel modules via one or more serrated hinges.

7. The photovoltaic system of claim 1, wherein the mounting bracket includes a plurality of belt loops sized to permit threading the strap of the belt therethrough.

8. The photovoltaic system of claim 1, wherein the mounting bracket includes a plurality of mounting holes that pass through the mounting bracket and are each sized to permit passage of a respective fastener therethrough.

9. The photovoltaic system of claim 1, comprising:
an upper solar panel comprising an upper solar panel module of the one or more solar panel modules; and
a lower solar panel comprising a lower solar panel module of the one or more solar panel modules.

10. The photovoltaic system of claim 9, comprising a first hinge that couples the upper solar panel to the lower solar panel.

11. The photovoltaic system of claim 10, wherein the mounting bracket is coupled to the lower solar panel via a second hinge.

12. The photovoltaic system of claim 11, wherein a housing of the lower solar panel comprises a recess sized to receive the mounting bracket.

13. The photovoltaic system of claim 12, wherein the second hinge permits retracting the mounting bracket within the housing of the lower solar panel.

14. The photovoltaic system of claim 1, comprising:
one or more battery cells; and
first charging circuitry configured to charge the one or more battery cells based on electrical power provided by the one or more solar panel modules.

15. The photovoltaic system of claim 14, comprising:
a charging port; and
second charging circuitry configured to charge the one or more battery cells based on electrical power provided by the charging port.

16. The photovoltaic system of claim 14, comprising a micro-controller configured to monitor a power level of the one or more battery cells.

17. The photovoltaic system of claim 16, wherein the micro-controller is configured to control an illumination status of one or more light-emitting diodes based on the monitored power level of the one or more battery cells.
